(19) United States
(12) Patent Application Publication
(10) Pub. No.: US 2007/0216195 A1
(43) Pub. Date: Sep. 20, 2007

(54) Plastic cargo bed

(75) Inventor: Christopher K. Furman, Augusta, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/375,677

(22) Filed: Mar. 14, 2006

(51) Int. Cl. B62D 33/02

(52) U.S. Cl. 296/183.1

(57) ABSTRACT

A cargo bed assembly including a cargo bed base; a first side wall extending from the base; a second side wall extending from the base, the second side wall located opposite the first side wall; a tailgate having an inner side facing the base and an outer side opposite to the inner side, the tailgate positioned between the first sidewall and the second side wall; and a first latch assembly mounted to the outer side of the tailgate, the first latch assembly including a first latch pin operable to engage and disengage the first side wall.

### FIELD

The present disclosure relates to a method and apparatus for a utility vehicle cargo bed.

### BACKGROUND

The statements in this section merely provide background information related to the present disclosure and may not constitute prior art.

Utility vehicles can be equipped with cargo beds to haul various items. While existing cargo beds are suitable for their intended purposes, they are subject to improvement.

### SUMMARY

The present teachings provide for a cargo bed assembly for a utility vehicle. The cargo bed assembly can include a cargo bed base; a first side wall extending from the base; a second side wall extending from the base, the second side wall located opposite the first side wall; a tailgate having an inner side facing the base and an outer side opposite to the inner side, the tailgate positioned between the first sidewall and the second side wall; and a first latch assembly mounted to the outer side of the tailgate, the first latch assembly including a first latch pin operable to engage and disengage the first side wall.

The present teachings can further provide for a cargo bed assembly for a utility vehicle including a cargo bed base having a rear surface; a first sidewall extending from the base; a second side wall extending from the base, the second side wall located opposite the first side wall; and a center flange extending from the rear surface. The center flange can include a center portion mounted directly to the rear surface; a first extension extending from a first end of the center portion, the first extension is spaced apart from the rear surface of the cargo bed; and a second extension extending from a second end of the center portion that is opposite the first end, the second extension is spaced apart from the cargo bed. The cargo bed assembly can further include a tailgate including a center receptacle operable to cooperate with the center flange.

The present teachings can also provide for a utility vehicle. The utility vehicle can include a front end; a rear end; a seat assembly having a seat back support post; a cargo bed mounted proximate to the rear end of the utility vehicle. The cargo bed can include a base; a forward wall extending from the base, the forward wall having a front side opposing the seat back support post and a rear side facing the rear end of the utility vehicle; and a recess disposed in the front side of the forward wall opposite the seat back support post.

The present teachings can further provide for a cargo bed assembly for a utility vehicle that can include a cargo bed base; a first side wall extending from the base; a tapered first side pocket within the first side wall, the first side pocket is tapered such that it is more narrow proximal to the base than distal to the base.

The present teachings can still further include a cargo bed assembly for a utility vehicle including a utility vehicle frame; a stop device mounted to the frame; a cargo bed base pivotally mounted to the frame; an undersurface of the base; and a recess formed within the undersurface of the base, the recess positioned such that it receives the stop device when the cargo bed is in a horizontal position relative to the frame.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a side view of a utility vehicle in accordance with the present teachings;

FIG. 2 is a perspective view of an upper portion of a cargo bed of the utility vehicle of FIG. 1, the cargo bed having a tailgate in a closed position;

FIG. 3 is a perspective view of an undersurface of the cargo bed;

FIG. 4 is a cross-sectional view taken along line 44 of FIG. 1;

FIG. 5 is a perspective view of the cargo bed in a raised position;

FIG. 6 is a side view of a divider-rail pocket and a stake-side pocket of the cargo bed;

FIG. 7 is a top view of the divider-rail pocket and the stake-side pocket of FIG. 6;

FIG. 8 is a perspective view of the cargo bed including a first and a second divider rail;

FIG. 9 is a perspective view of the cargo bed including a first stake-side and a second stake-side;

FIG. 10 is a perspective view of a rear end of the cargo bed showing a tailgate of the cargo bed detached from the cargo bed;

FIG. 11 is a perspective view of an outer side of the tailgate detached from the cargo bed;

FIG. 12 is a perspective view of a locking mechanism of the tailgate;

FIG. 13 is a perspective view of the tailgate at an open position; and

FIG. 14 is a perspective view of the tailgate rotated 180° relative to the closed position of FIG. 2.

### DETAILED DESCRIPTION

The following description is merely exemplary in nature and is in no way intended to limit the present disclosure, application, or uses. Throughout this specification, like reference numerals will be used to refer to like elements.

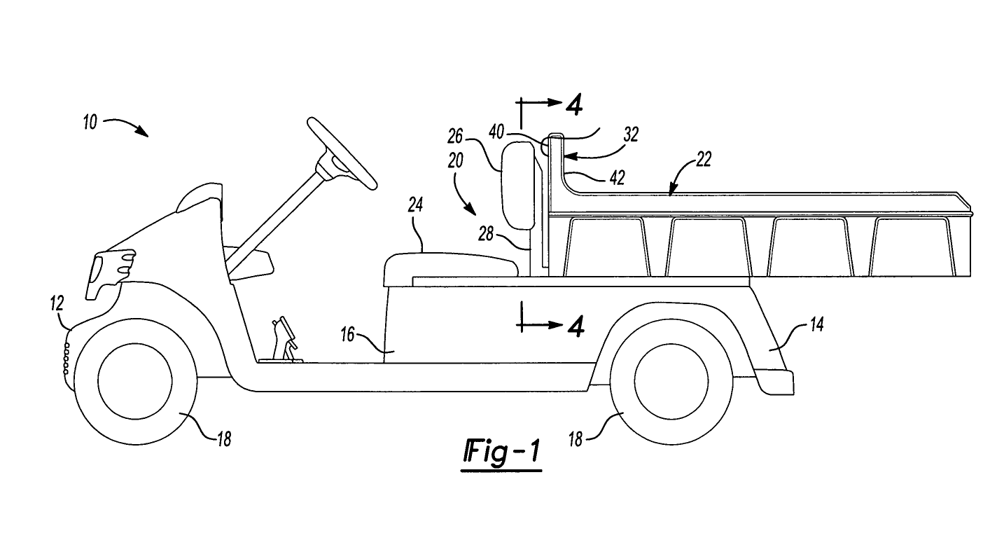

A utility vehicle according to the present teachings is illustrated in FIG. 1 at reference numeral 10. The utility vehicle 10 can include a front end 12, a rear end 14, a body 16, and a plurality of wheels 18 that can support the body 16. Mounted to the body 16 can be a seat assembly 20 and a cargo bed 22.

The seat assembly 20 can include a seat base 24 and a seat back 26. The seat base 24 can be directly mounted to the body 16. The seat back 26 can be mounted to the body 16 by a suitable support, such as by one or more support posts 28. The support post 28 can protrude from the seat back 26 in the direction of the rear end 14 of the vehicle 10.

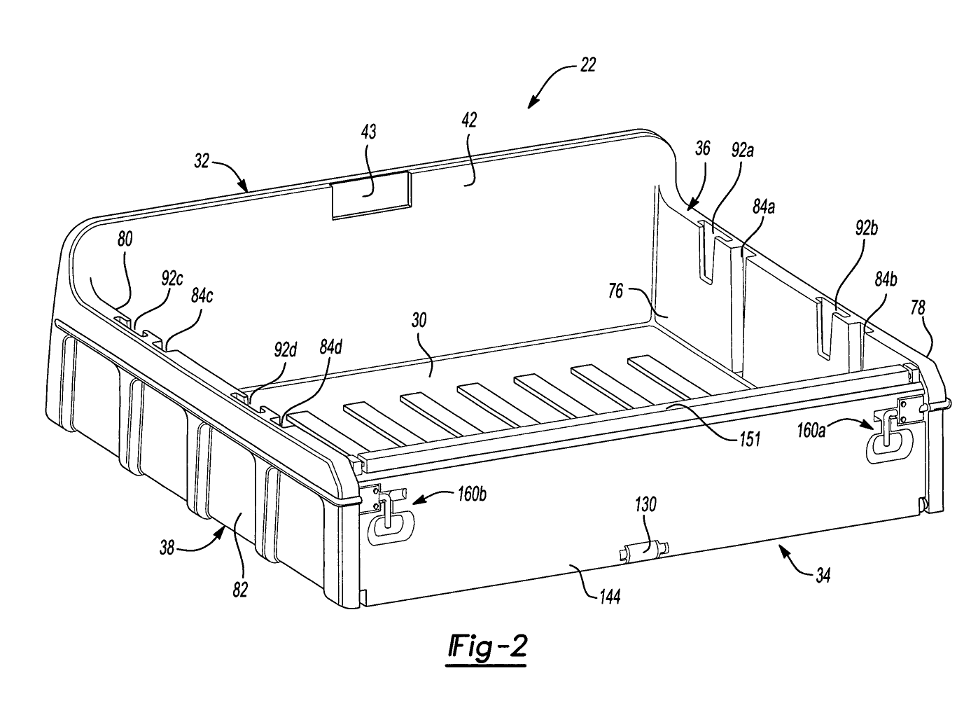

With additional reference to FIG. 2, the cargo bed 22 can include a base 30, a forward wall 32, a tailgate 34, a first side wall 36, and a second side wall 38. The forward wall 32 and the tailgate 34 can be at opposite ends of the base 30. The forward wall 32 and the tailgate 34 can be parallel to each other. The first side wall 36 and the second side wall 38 can be at opposite sides of the base 30 between the forward wall 32 and the tailgate 34. The first side wall 36 and the second side wall 38 can be parallel to each other and perpendicular to the forward wall 32 and the tailgate 34 to provide the cargo bed 22 with a generally square or rectangular shape.

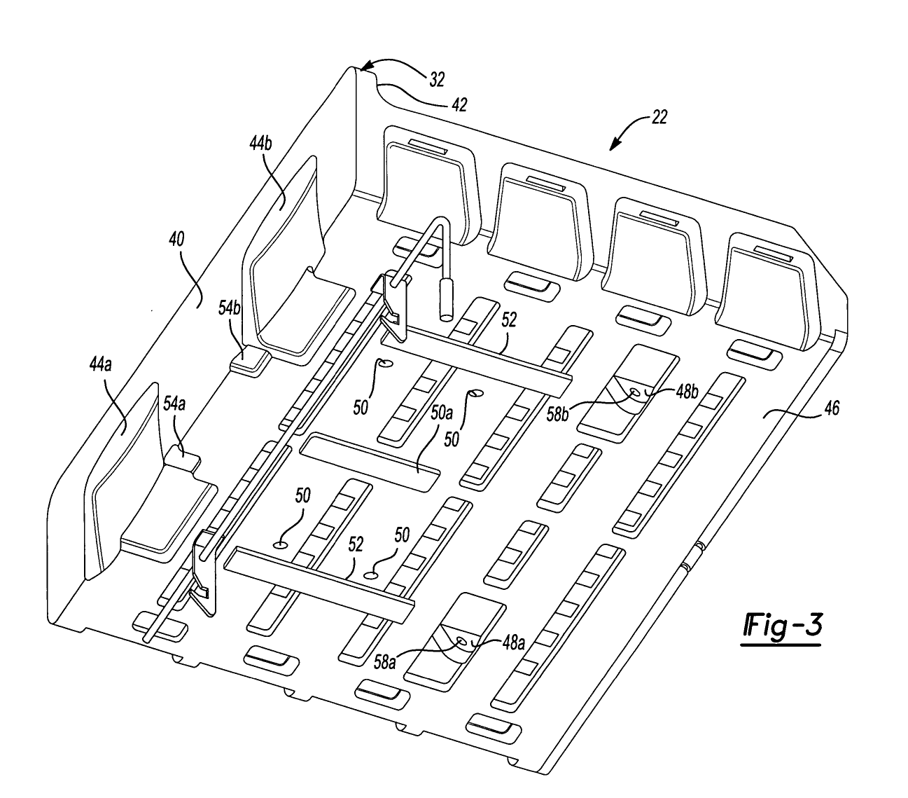

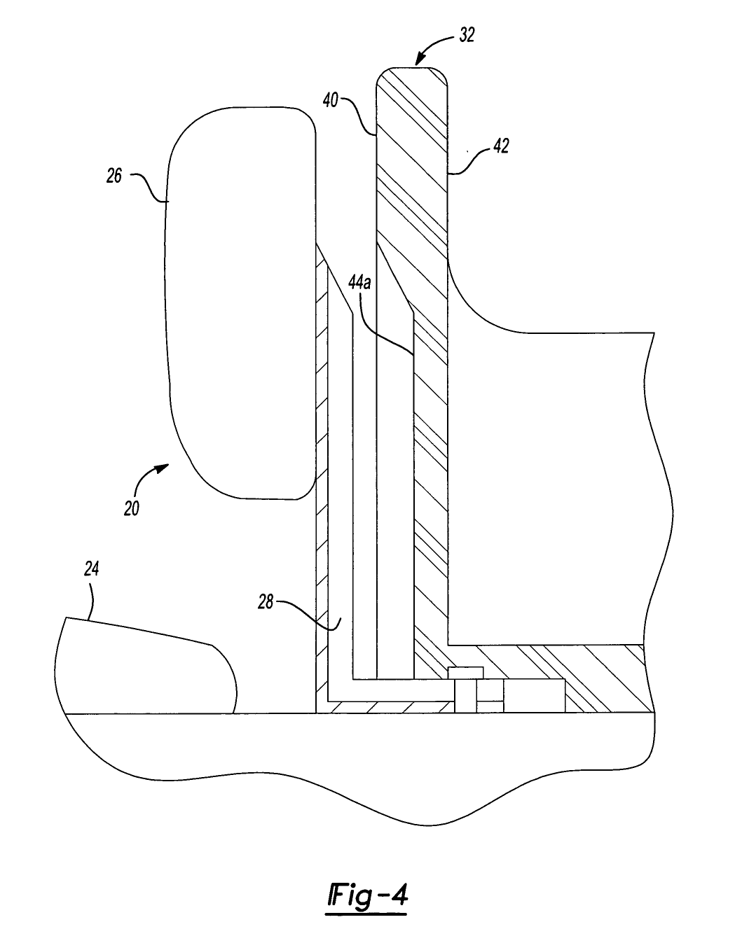

With continued reference to FIGS. 1 and 2 and additional reference to FIGS. 3 and 4, the forward wall 32 can include a front side 40 and a rear side 42 opposite the front side 40. The front side 40 can face the front end 12 of the vehicle 10 and the rear side 42 can face the rear end 14 of the vehicle 10.

The rear side 42 can include a recess or indentation 43. The indentation 43 can be used to receive a label or decal, such as a warning or loading decal. The indentation 43 can be formed in any suitable manner, such as by being stamped or molded within the forward wall 32.

The front side 40 can include one or more recesses 44, such as a first recess 44a and a second recess 44b. As illustrated in FIG. 4, the first recess 44a can be positioned such that it is opposite to the support post 28 of the seat back 26 when the cargo bed 22 is in the illustrated lowered position. The second recess 44b can also be positioned opposite the support post 28.

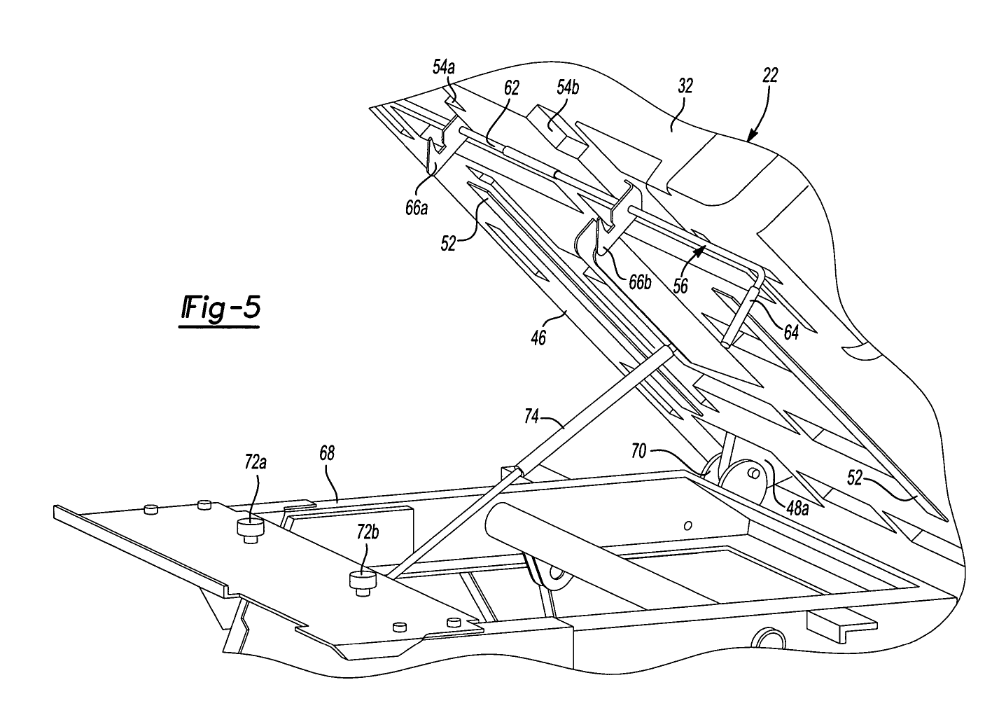

The recesses 44 can provide additional clearance between the forward wall 32 of the cargo bed 22 and the support posts 28. The additional clearance provided by the recesses 44 can allow the forward wall 32 to be positioned closer to the seat back 26, thereby increasing the size of the cargo bed 22. Without the recesses 44, the forward wall 32 would have to be moved further toward the rear end 14 of the vehicle 10, thus decreasing the size of the bed 22, to prevent the front side 40 of the forward wall 32 from contacting the support posts 28 in applications where the cargo bed 22 can pivot between a lowered position (FIG. 1) and a raised position (FIG. 5).

With reference to FIGS. 3 and 5, the cargo bed 22 can further include an undersurface 46 that can be opposite to the base 30. The undersurface 46 can include one or more flanges 48, one or more mounting locations 50, one or more support pads 52, one or more bed stop receivers 54, and a latch assembly 56.

The one or more flanges 48 can include a first flange 48a and a second flange 48b. The flanges 48a and 48b can protrude from the undersurface 46 of the cargo bed 22. The flanges 48a and 48b can each include an aperture 58a and 58b respectively. The flanges 48 can be positioned so that the apertures 58a and 58b are aligned in parallel.

The mounting locations 50 can be any suitable feature formed or mounted to the undersurface 46 of the cargo bed 22 that can facilitate the mounting of one or more accessories to the undersurface 46. For example, threaded inserts can be provided at the mounting locations 50. The threaded inserts can be made of any suitable material, such as steel. In applications where the cargo bed 22 is made of an injection molded polymer, the inserts can be mounted to the mold and the polymer can be injected around the insert to secure the insert to the cargo bed 22. Suitable fastening devices, such as threaded bolts, can cooperate with the threads of the insert. Suitable accessories can be secured to the undersurface 46 by the bolts

The support pads 52 can be formed integral with the cargo bed 22 or can be separate components attached to the cargo bed 22. The support pads 52 can be planar with the undersurface 46 or can extend slightly from the undersurface 46. The support pads 52 can be planar pads that allow the cargo bed 22 to rest on and be supported by a generally planar surface, as further described below. The support pads 52 can be provided with vibration absorption features.

The bed stop receivers 54 can include a first bed stop receiver 54a and a second bed stop receiver 54b. The bed stop receivers 54 can take the form of two recesses in the undersurface 46 that are proximate to the forward wall 32.

The latch assembly 56 can include a rod 62, a handle 64, and at least one latch 66. The rod 62 can be rotationally mounted to the undersurface 46 of the cargo bed 22 proximate to the forward wall 32 and can extend between the first side wall 36 and the second side wall 38. The handle 64 can be integral with the rod 62 or can be a separate part suitably mounted to the rod 62. As illustrated, the handle 64 can extend from the rod 62 at about a ninety degree angle relative to the rod 62. The at least one latch 66 can include a first latch 66a and a second latch 66b. The latches 66a and 66b can be mounted to the rod 62 such that actuation of the handle 64 can cause the latches 66a and 66b to pivot.

With reference to FIG. 5, the cargo bed 22 can be mounted to a frame 68 of the vehicle 10. The frame 68 can include one or more mounts 70 that can be at the rear end 14 of the vehicle 10. The mounts 70 can be any mount suitable to engage the flanges 48 of the cargo bed 22. The cargo bed 22 can be mounted to the frame 68 by coupling the flanges 48 to the mounts 70. The flanges 48 can be coupled to the mounts 70 using any suitable fastening device or method. The cargo bed 22 can be rotationally mounted to the frame 68 to allow the cargo bed 22 to pivot between the lowered position (FIG. 1) and the raised position (FIG. 5).

The frame 68 can include one or more bed stops or bumpers 72. The bumpers 72 can be any suitable shock absorbing surface, such as a rubber stop. The bumpers 72 can include a first bumper 72a and a second bumper 72b that protrude from the frame 68. The height that the bumpers 72a and 72b can protrude can be adjustable. The bumpers 72a and 72b can be mounted to the frame 68 such that the first bumper 72a abuts the first bed stop receiver 54a and the second bumper 72b abuts the second bed stop receiver 54b when the cargo bed 22 is in the lowered position of FIG. 1.

The bumpers 72a and 72b provide a soft cushion for the cargo bed 22 to prevent the cargo bed 22 or the frame 68 from being damaged when the cargo bed 22 is lowered onto the frame 68. The distance that the bumpers 72 support the cargo bed 22 from the frame 68 can be adjusted by increasing or decreasing the height of the bumpers 72.

To facilitate movement of the cargo bed 22 between the lowered position and raised position, the vehicle 10 can be equipped with an actuating device 74. The actuating device 74 can be mounted to the frame 68 at one end and to the mounting locations 50 of the undersurface 46 of the cargo bed 22, such as at a center mounting location 50a, at an opposite end. The actuating device 74 can be any suitable actuating device 74, such as a fluid filled piston.

Additional support for the cargo bed 22 on the frame 68 can be provided by the support pads 52. When the cargo bed 22 is in the lowered position the support pads 52 can abut the frame 68. The support pads 52 can provide a solid, planar surface for the cargo bed 22 to contact the frame 68 so that the cargo bed 22 can be properly supported on the frame 68.

To secure the cargo bed 22 in the lowered position of FIG. 1, the handle 64 of the of the latch assembly 56 can be rotated to pivot the latches 66a and 66b into engagement with the frame 68. With the latches 66a and 66b secured to the frame 68, the cargo bed 22 is restricted from pivoting to the raised position of FIG. 5. Thus, undesired movement of the cargo bed 22 can be prevented. The handle 64 can be rotated in the opposite direction to remove the latches 66a and 66b from engagement with the frame 68.

With renewed reference to FIG. 2, the first side wall 36 can include an inner surface 76 and an outer surface 78. The inner surface 76 can face the second side wall 38. The outer surface 78 can be opposite to the inner surface 76. The second side wall 38 can include an inner surface 80 and an outer surface 82. The inner surface 80 can face the first side wall 36 and the outer surface 82 can be opposite the inner surface 80.

The first side wall 36 can include one or more divider rail pockets 84. As illustrated, the first side wall 36 can include a first divider rail pocket 84a and a second divider rail pocket 84b. The first divider rail pocket 84a can be substantially similar to the second divider rail pocket 84b. Therefore, the below description of the first divider rail pocket 84a equally applies to the second divider rail pocket 84b.

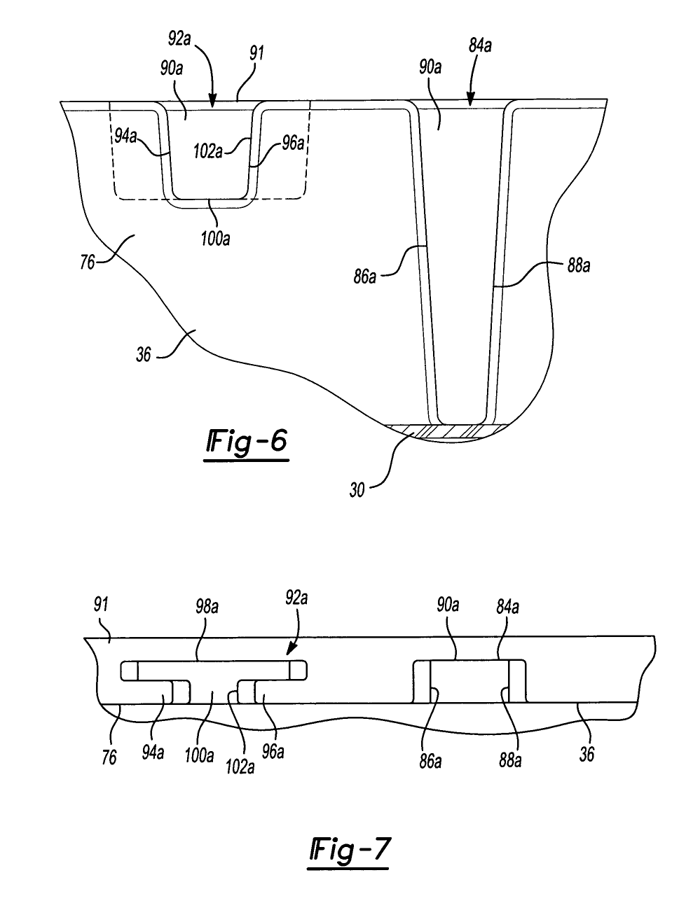

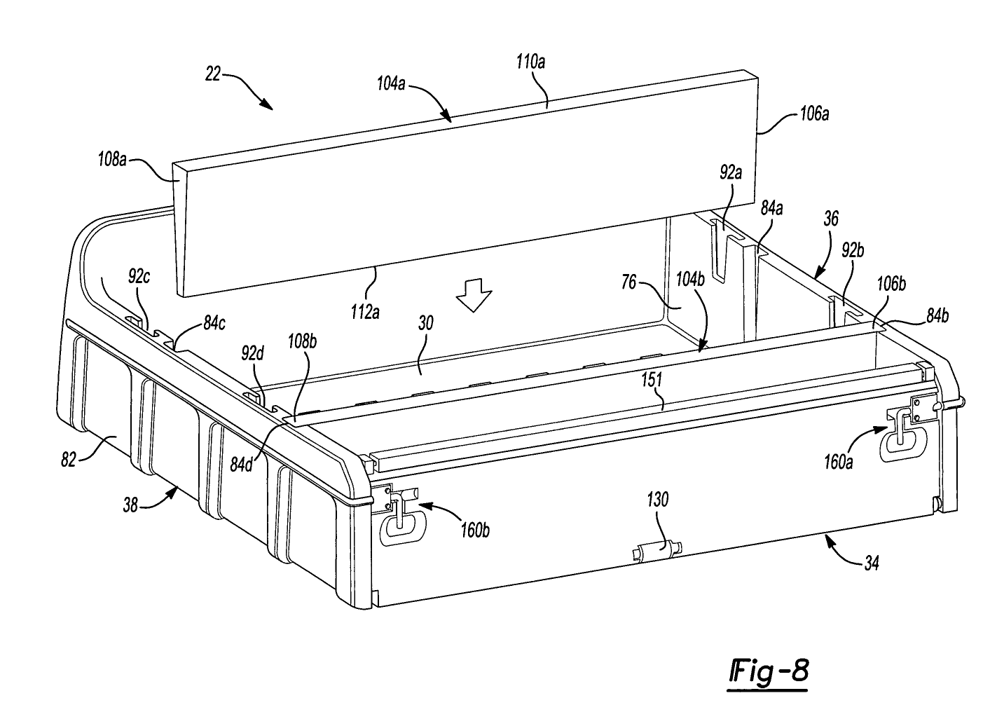

With additional reference to FIGS. 6 and 7, the first divider rail pocket 84a can be recessed within the inner surface 76 of the first side wall 36. The first divider rail pocket 84a can include a first side wall 86a, a second side wall 88a, and a rear wall 90a. The first side wall 86a can be spaced apart from and opposite to the second side wall 88a. The rear wall 90a can be orientated at approximately 90° relative to both the first side wall 86a and the second side wall 88a and can extend between the first and second side walls 86a and 88a.

The first side wall 86a and the second side wall 88a can extend from the base 30 of the cargo bed 22 to a top portion 91 of the first side wall 36. The first side wall 86a and the second side wall 88a can be angled or tapered such that the side walls 86a and 88a are closest together at the base 30 and furthest apart at the top portion 91.

The second side wall 38 can include a third divider rail pocket 84c and a fourth divider rail pocket 84d. The third divider rail pocket 84c can be positioned opposite the first divider rail pocket 84a and the fourth divider rail pocket 84d can be positioned opposite the second divider rail pocket 84b. The third and fourth divider rail pockets 84c and 84d can each be similar to the first divider rail pocket 84a. Therefore, the above description of the first divider rail pocket 84a equally applies to the third and fourth divider rail pockets 84c and 84d.

With continued reference to FIGS. 2, 6, and 7, the first side wall 36 can further include one or more stake-side pockets 92. As illustrated, the first side wall 36 can include a first stake-side pocket 92a and a second stake side pocket 92b. The first stake-side pocket 92a can be substantially similar to the second stake-side pocket 92b. Therefore, the below description of the first stake-side pocket 92a equally applies to the second stake-side pocket 92b.

The first stake-side pocket 92a can be recessed within the inner surface 76 of the first side wall 36. The first stake-side pocket 92a can include a first flange 94a, a second flange 96a, a rear wall 98a, and a bottom 100a. The first flange 94a and the second flange 96a can be in general alignment with each other and can be spaced apart from the rear wall 98. The first and second flanges 94a and 96a can extend from the bottom 100a to the top portion 91 of the first side wall 36. The bottom 100a can be spaced apart from the base 30 of the cargo bed 22 so that the first stake-side pocket 92a extends less than the entire height of the first side wall 36.

The first and second flanges 94a and 96a can be tapered such that the first and the second flanges 94a and 96a are closest together at the bottom 100a and furthest apart at the top portion 91 of the first side wall 36. The first stake-side pocket 92a can also be tapered from the top portion 91 to the bottom 100a such that the pocket 92a is widest at the top portion 91 and most narrow at the bottom 100a. The first and second flanges 94a and 96a can define an opening 102a between the flanges 94a and 96a. The opening 102a can permit the passage of, for example, dirt and mud out from within the stake-side pocket 92a.

The second side wall 38 can include a third stake-side pocket 92c and a fourth stake-side pocket 92d. The third stake-side pocket 92c can be positioned opposite the first stake-side pocket 92a and the fourth stake-side pocket 92d can be positioned opposite the second stake-side pocket 92b. The third and fourth stake-side pockets 92c and 92d can each be the same as the first stake-side pocket 92a. Therefore, the above description of the first stake-side pocket 92a equally applies to the third and the fourth stake-side pockets 92c and 92d.

With additional reference to FIG. 8, the cargo bed 22 can further include at least one divider rail 104. As illustrated, the cargo bed 22 can include a first divider rail 104a and a second divider rail 104b.

The first divider rail 104a can generally be an elongated rail or panel that can include a first end 106a, a second end 108a, a top surface 110a, and a bottom surface 112a. The first end 106a and the second end 108a can each be tapered from the top surface 110a to the bottom surface 112a such that the first divider rail 104a can be widest at the top surface 110a and can be most narrow at the bottom surface 112a. The first end 106a and the second end 108a can be tapered to match the dimensions of the tapered divider rail pockets 84.

The first divider rail 104a can be positioned in the cargo bed 22 such that it extends between the first side wall 36 and the second side wall 38 with the first end 106a seated within the first divider rail pocket 84a and the second end 108a seated within the third divider rail pocket 84c to secure the divider rail 104a into position.

The second divider rail 104b can be substantially similar to the first divider rail 104a. Therefore, the above description of the first divider rail 104a can equally apply to the second divider rail 104b. The common features of first divider rail 104a and the second divider rail 104b are designated using the same reference numbers, the features of the first divider rail 104a including the letter “a” and the features of the second divider rail 104b including the letter “b”.

The second divider rail 104b can also be positioned between the first side wall 36 and the second side wall 38. In particular, the second divider rail 104b can be positioned such that the first end 106b is seated within the second divider rail pocket 84b and the second end 108b is seated within the fourth divider rail pocket 84d to secure the divider rail into position.

The first and second divider rails 104a and 104b can be used to divide the cargo bed 22 into different areas or sections to separate items placed within the cargo bed 22. Cooperation between the first and the second sides 106 and 108 of the divider rails 104 and the divider rail pockets 84 can be enhanced because both the first and the second sides 106 and 108 and the divider rail pockets 84 can be tapered.

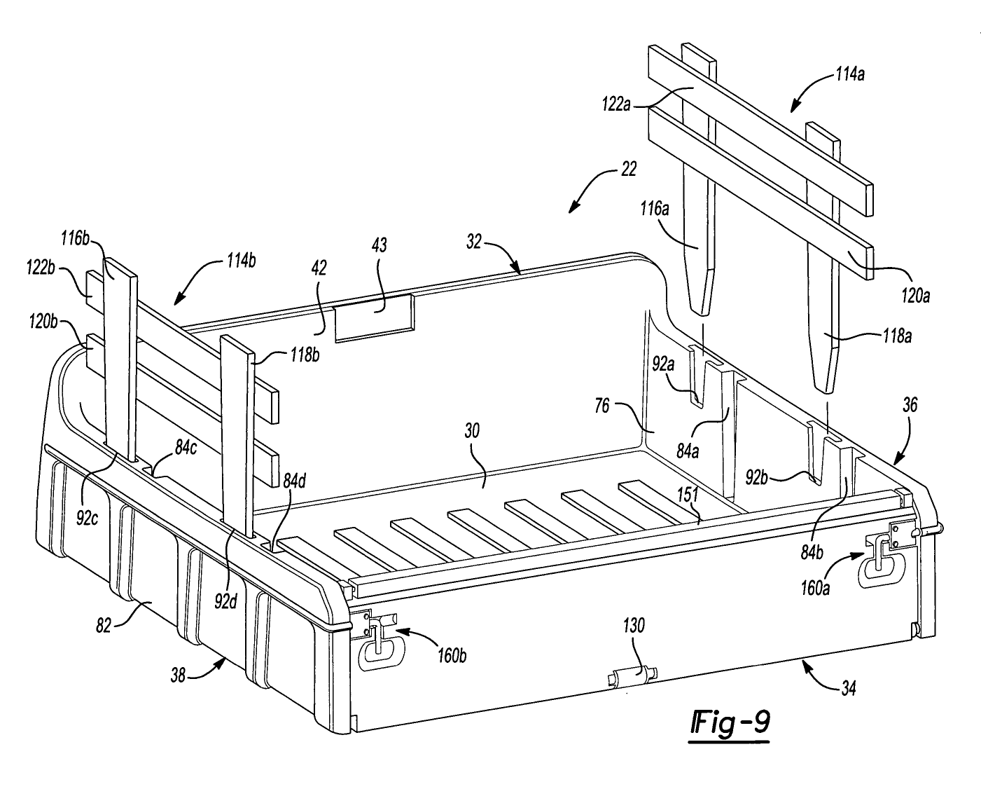

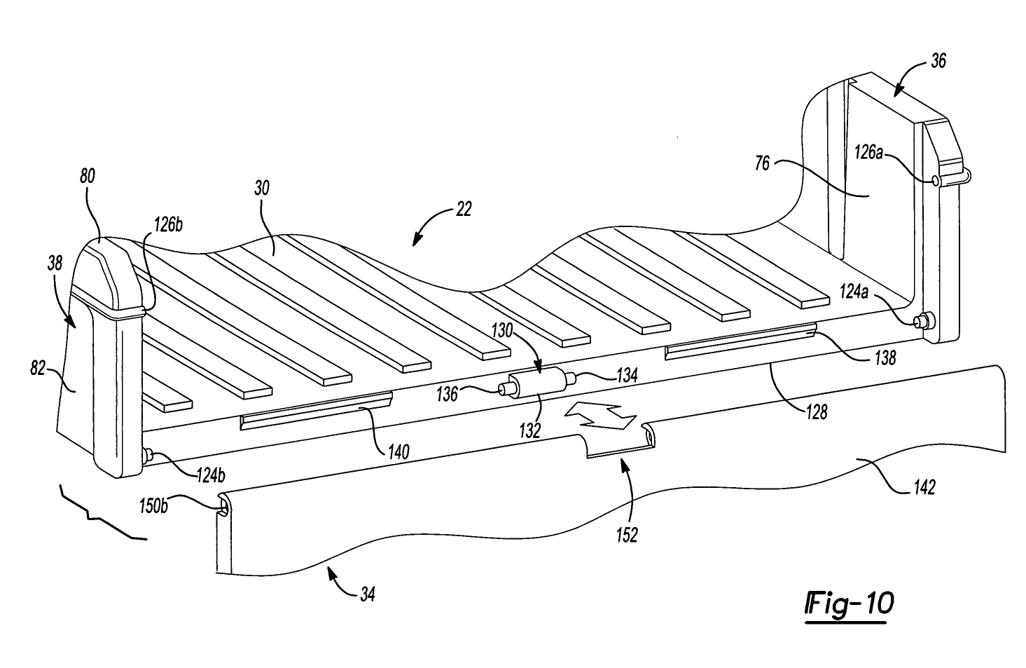

With reference to FIG. 9, the cargo bed 22 can further include at least one stake side 114. As illustrated, the cargo bed 22 can include a first stake side 114a and a second stake side 114b. The first and second stake sides 114a and 114b can be substantially similar. Therefore, the description of the first stake side 114a equally applies to the second stake side 114b and like features are illustrated using like reference numbers. The features of the first stake side 114a include the letter “a” and the features of the second stake side 114b include the letter “b”.

The first stake side 114a can include a first stake 116a and a second stake 118a. The first stake 116a can be parallel to the second stake 118a. The first stake 116a and the second stake 118a can each be tapered at their respective tips to match the tapered stake-side pockets 92a and 92b respectively.

A first cross bar 120a can extend between the first stake 116a and the second stake 118a to connect the first stake 116a to the second stake 118a. A second cross bar 122a can also extend between the first stake 116a and the second stake 118a. The first cross bar 120a can be parallel to the second cross bar 122a.

The first stake side 114a can be mounted to the first side wall 36. The first stake side 114a can be mounted to the first side wall 36 by inserting the tapered first stake 116a within the tapered first stake-side pocket 92a and the tapered second stake 118a within the tapered second stake-side pocket 92b.

The first stake side 114a can be used to extend the height of the first side wall 36. The cooperation between the first and second stakes 116a and 118a and the first and second stake-side pockets 92a and 92b respectively can be enhanced by the taper fit between the tapered stakes 116a and 118a and the tapered stake-side pockets 92a and 92b respectively.

The second stake side 114b can be used to extend the height of the second side wall 38. The second stake side 114b can be mounted to the second side wall 38 using the third and fourth stake-side pockets 92c and 92d in the same way that the first stake side 114a can be mounted to the first side wall 36.

With additional reference to FIG. 10, the first side wall 36 can further include a first side flange 124a. The first side flange 124a can protrude from the inner surface 76 of the first side wall 36. The first side flange 124a can be located at a portion of the first side wall 36 proximate to a rear end 128 of the base 30 of the cargo bed 22. The first side flange 124a can be integral with the first side wall 36 or can be inserted into cooperation with the first side wall 36. The inner surface 80 of the second side wall 38 can have a second side flange 124b that can be similar to the first side flange 124a and can be positioned opposite to and in alignment with the first side flange 124a.

The first side wall 36 can further include a first aperture 126a. The first aperture 126a can be recessed within the inner surface 76 of the first side wall 36. The first aperture 126a can be located above the first side flange 124a proximate to the top portion 91 of the first side wall 36. The second side wall 38 can have a second aperture 126b that can be similar to the first aperture 126a. The second aperture 126b can be positioned opposite to and in alignment with the first aperture 126a.

The cargo bed 22 can further include a center flange 130 extending from the rear end 128. The center flange 130 can include a center portion 132, a first extension 134, and a second extension 136. The center flange 130 can be mounted to the cargo bed 22 or can be molded together with the cargo bed 22.

The center portion 132 can be directly mounted to the rear end 128 of the cargo bed 22. The first extension 134 can extend from a first side of the center portion 132 and the second extension 136 can extend from a second side of the center portion 132. The first and second extension portions 134 and 136 can be spaced apart from the rear end 128 of the cargo bed 22 and can extend parallel to the rear end 128. The center portion 132 and the first and second extensions 134 and 136 can be cylindrical. The first and second extensions 134 and 136 can have a diameter that can be smaller than a diameter of the center portion 132.

The cargo bed 22 can further include a first lip 138 and a second lip 140. The first and second lips 138 and 140 can protrude from the rear end 128 of the cargo bed 22 at opposite sides of the center flange 130. The first lip 138 and the second lip 140 can be positioned proximate to the base 30 of the cargo bed 22 and can be planar with the base 30. The first and second lips 138 and 140 can be mounted to the cargo bed 22 or can be formed integral with the cargo bed 22.

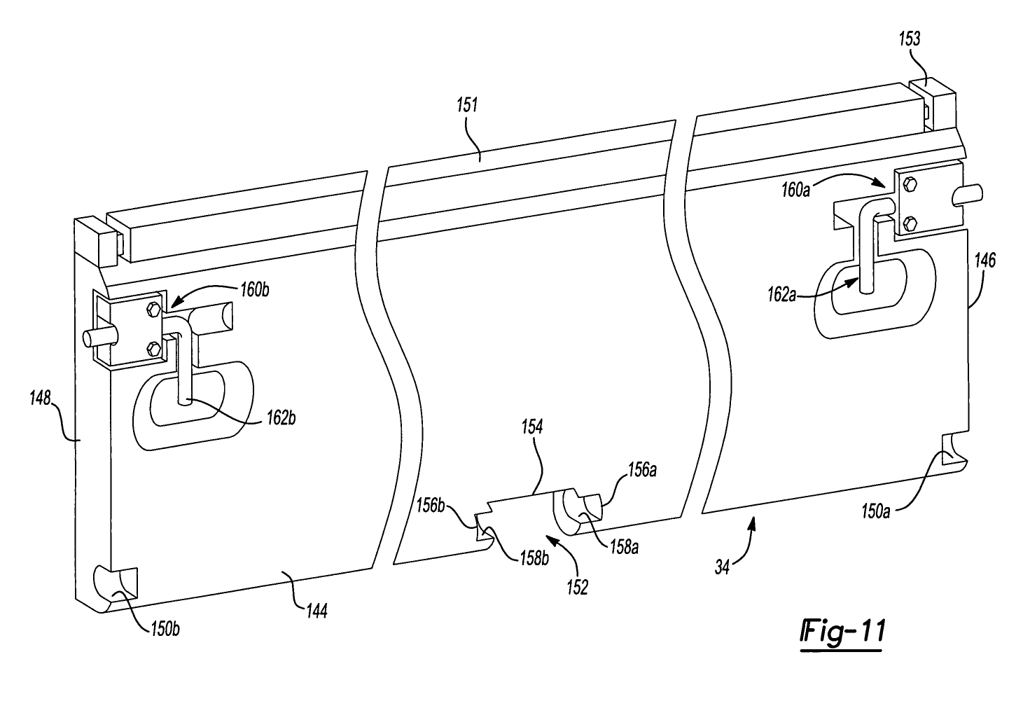

With additional reference to FIG. 11, the tailgate 34 can include an inner side 142, an outer side 144, a first end 146, and a second end 148. When the tailgate is in the closed position of FIG. 2, the inner side 142 can face the forward wall 32 of the cargo bed 22. The outer side 144 can be opposite to the inner side 142. The first end 146 can abut the first side wall 36 and the second end 148 can abut the second side wall 38.

The tailgate 34 can further include a first recess 150a at the first end 146 and a second recess 150b at the second end 148. The first and second recesses 150a and 150b can be open at the outer side 144 of the tailgate 34 and can be closed at the inner side 142. Both of the recesses 150a and 150b can be open at the first end 146 and the second end 148 of the tailgate 34 respectively. The recesses 150a and 150b can be sized to receive the first side flange 124a and the second side flange 124b respectively.

The tailgate 34 can further include a rigid rod or extrusion 151. The extrusion 151 can be positioned along an upper surface 153 of the tailgate 34 between the first end 146 and the second end 148. The extrusion 151 can be made of any suitable material, such as aluminum. The extrusion 151 can provide additional strength to the tailgate 34 to prevent it from bending under stress that might be applied to the tailgate 34 by a load placed within the cargo bed 22.

The tailgate 34 can further include a center receptacle 152. The center receptacle 152 can be between the first end 146 and the second end 148 of the tailgate 34. The center receptacle 152 can include a center or middle portion 154, a first side portion 156a at one end of the middle portion 154, and a second side portion 156b at an opposite end of the middle portion 154.

The middle portion 154 can extend through the tailgate 34 from the inner side 142 to the outer side 144. Thus, the middle portion 154 can be open at both the inner side 142 and the outer side 144 of the tailgate 34. The middle portion 154 can be sized to receive the center portion 132 of the center flange 130.

The first side portion 156a is open at the outer side 144 of the tailgate 34 and is bordered by an inner wall 158a at the inner side 142 of the tailgate 34. The first side portion 156a can be sized to receive the first extension 134 of the center flange 130. Similarly, the second side portion 156b can be open at the outer side 144 and can be bordered by an inner wall 158b at the inner side 142 of the tailgate 34. The second side portion 156b can be sized to receive the second extension 136 of the center flange 130.

A first locking mechanism 160a can be mounted at the first end 146 of the outer side 144 of the tailgate 34 and a second locking mechanism 160b can be mounted at the second end 148 of the outer side 144. The first locking mechanism 160a can be similar to the second locking mechanism 160b. Therefore, the description of the first locking mechanism 160a equally applies to the second locking mechanism 160b. The common features of the first and the second locking mechanisms 160a and 160b are illustrated using the same reference numbers, the reference numbers of the first locking mechanism 160a further including the letter “a” and the reference numbers of the second locking mechanism 160b further including the letter “b”.

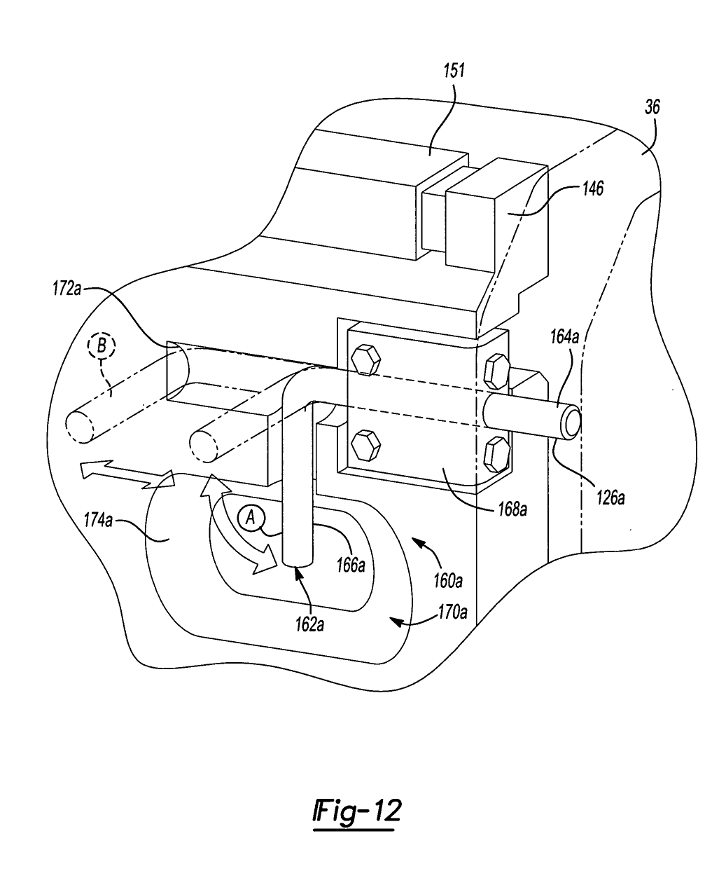

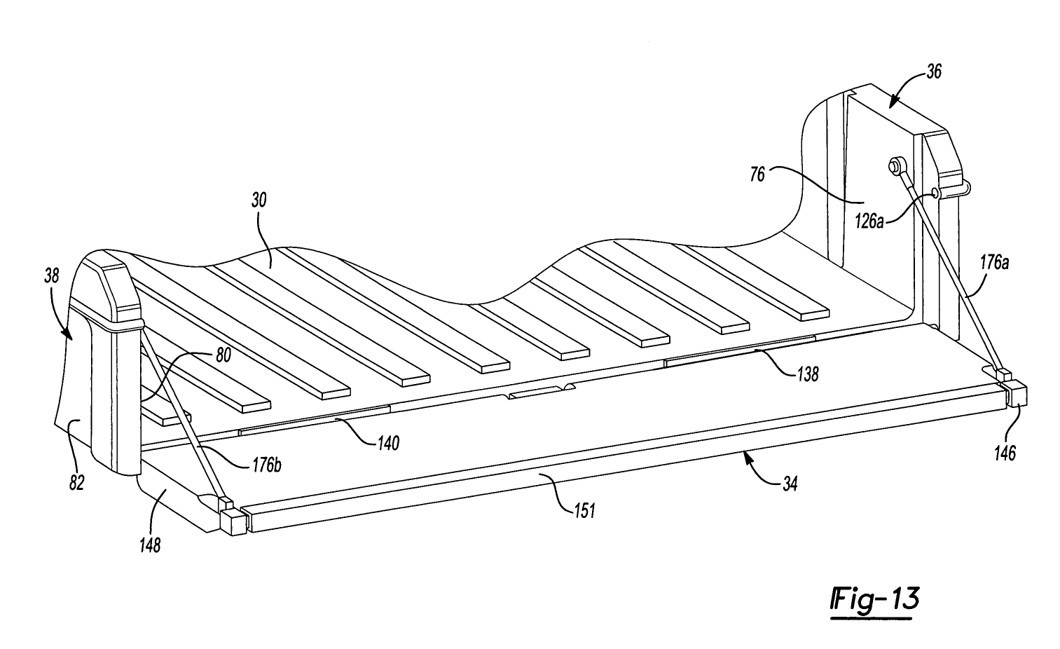

With additional reference to FIG. 12, the first locking mechanism 160a can include a first latch pin 162a. The first latch pin 162a can include a first portion 164a and a second portion 166a. The first portion 164a and the second portion 166a can be angled at about 90° relative to each other. The first latch pin 162a can be made of any suitable material, such as steel.

The first latch pin 162a can be mounted to the tailgate 34 by a first mounting plate 168a. The first mounting plate 168a can be mounted to the tailgate 34 in any suitable manner. The first portion 164a of the first latch pin 162a can be slidably seated between the first mounting plate 168a and the tailgate 34 to slidably mount the first latch pin 162a to the tailgate 34.

The first locking mechanism 160a can further include a first recessed area 170a. The first recessed area 170a can include a first depression 172a that can be connected to a second depression 174a. The depressions 172a and 174a can be formed within the outer side 144 of the tailgate 34.

With renewed reference to FIG. 2, the tailgate 34 can be mounted to the rear end of the cargo bed 22 through cooperation between the center flange 130 and the center receptacle 152, as well as cooperation between the first and second side flanges 124a and 124b and the first and second recesses 150a and 150b respectively.

As illustrated in FIG. 10, in order to mount the tailgate 34 to the center flange 130 and the first and second side flanges 124a and 124b, the tailgate 34 can be orientated about 180° relative to the closed position of FIG. 2 so that the outer side 144 can face the flanges 130, 124a, and 124b. When the tailgate 34 is in this position, the center receptacle 152 can be placed over the center flange 130 because the middle portion 154 and the first and second side portions 156a and 156b are open at the outer side 144 of the tailgate 34. Also, the recesses 150a and 150b can be placed over the side flanges 124a and 124b respectively because the recesses 150a and 150b are open on the outer side 144 of the tailgate 34.

After the center flange 130 is seated within the center receptacle 152 and the recesses 150a and 150b are placed over the side flanges 124a and 124b respectively, the tailgate 34 can be rotated 180° to the closed position of FIG. 2 to secure the tailgate 34 to the base 30 of the cargo bed 22. Because the recesses 150a and 150b, as well as the side portions 156a and 156b of the center receptacle 152 are closed at the inner side 142, the tailgate 34 can not be removed from cooperation with the center flange 130 and the side flanges 124 when the tailgate 34 is in the closed position.

The tailgate 34 can be locked in the closed position of FIG. 2 using the first and second locking mechanisms 160a and 160b. As illustrated in FIG. 12, the latch pin 162a of the first locking mechanism 160a can be moved between a locked position A and an unlocked position B, which is shown in phantom. When the latch pin 162a is in the locked position A, the first portion 164a of the latch pin 162a can extend from the first end 146 of the tailgate 34 to engage the first aperture 126a of the first side wall 36. To secure the latch pin 162a in the locked position A, the second portion 166a of the latch pin 162a can be rotated downward so that it is seated within the second depression 174a of the first recessed area 170a. The cooperation between the first aperture 126a and the first latch pin 162a can secure the tailgate 34 in the closed position of FIG. 2. In a similar manner, the second locking mechanism 160b can engage the second aperture 126b to further secure the tailgate 34 in the closed position.

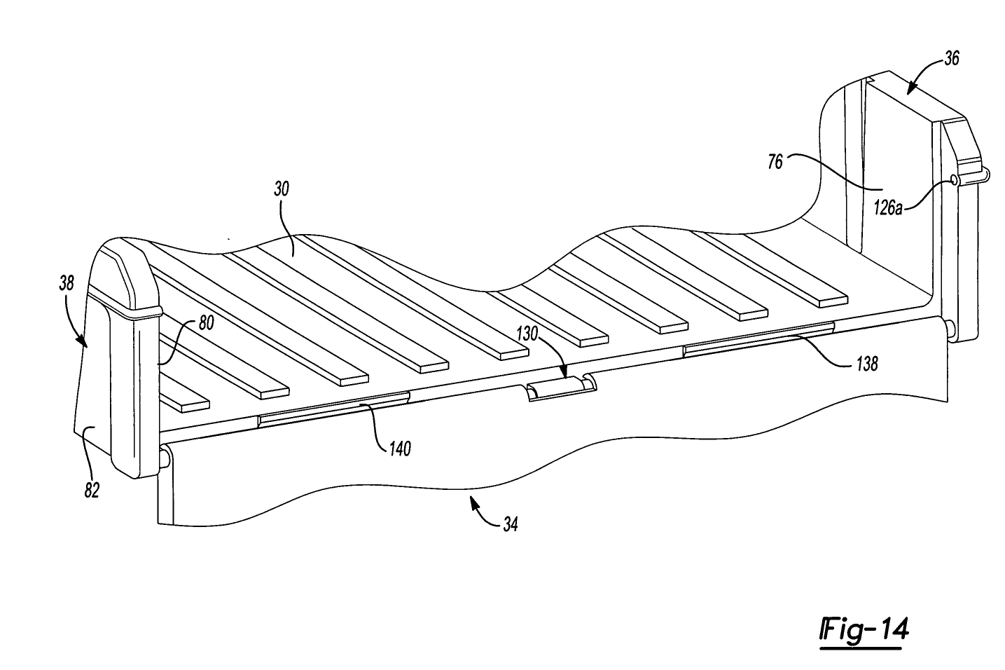

To move the latch pin 162a to the unlocked position B, the latch pin 162a can be rotated out from within the second depression 174a to a position that is approximately perpendicular to the outer side 144 of the tailgate 34. The latch pin 162a can then be slid within the first depression 172a away from first end 146 of the tailgate 34 so that the first portion 164a of the latch pin 162a disengages the first aperture 126a. In a similar manner, the second latch pin 162b of the second locking mechanism 160b can be moved to the unlocked position to disengage the second aperture 126b. When the first and second latch pins 162a and 162b are moved to the unlocked positions, the tailgate 34 can be moved from the closed position of FIG. 2 to the open position of FIG. 13.

As illustrated in FIG. 13, the cargo bed 22 can further include a first tether 176a and a second tether 176b. The first tether 176a can be mounted to the inner surface 76 of the first side wall 36 and at or near the first end 146 of the tailgate 34. The second tether 176b can be mounted to the inner surface 80 of the second side wall 38 and at or near the second end 148 of the tailgate 34.

The first and second tethers 176a and 176b can be removably mounted. When the first and second tethers 176a and 176b are mounted in the position illustrated in FIG. 13, the tailgate 34 can only open about 90°, such that the tailgate 34 is approximately planar with the base 30 of the cargo bed 22. The first and second tethers 176a and 176b can be any suitable type of tether. For example, the first and second tethers 176a and 176b can include a rubber cord.

The presence of the tethers 176a and 176b prevent the tailgate 34 from rotating more than 90° from the closed position of FIG. 2. When the tailgate 34 is in the position of FIG. 13, the presence of the first and the second lips 138 and 140 prevent the tailgate 34 from being lifted from engagement with the center flange 130 and the first and the second flanges 124a and 124b. To remove the tailgate 34 from the vehicle 10, the tethers 176a and 176b can be removed to permit rotation of the tailgate 34 to the position of FIG. 14, which can be about 180° relative to the closed position of FIG. 2. The tailgate 34 can then be removed from cooperation with flanges 124a, 124b and 130 because the recesses 150a and 150b and the side portions 156a and 156b of the center receptacle 152 are open on the outer side 144 of the tailgate 34.

The cargo bed 22, including the tailgate 34, can be made of any suitable polymeric material, such as a crosslinked polyethylene, a linear low density polyethylene, or other comparable material.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. A cargo bed assembly for a utility vehicle comprising:
a cargo bed base;
a first side wall extending from said base;
a second side wall extending from said base, said second side wall located opposite said first side wall;
a tailgate having an inner side facing said base and an outer side opposite to said inner side, said tailgate positioned between said first sidewall and said second side wall; and
a first latch assembly mounted to said outer side of said tailgate, said first latch assembly comprising a first latch pin operable to engage and disengage said first side wall.

2. The cargo bed assembly of claim 1, wherein said first latch pin comprises a first portion and a second portion that is orientated at about 90° to said first portion.

3. The cargo bed assembly of claim 1, wherein said first latch pin comprises steel.

4. The cargo bed assembly of claim 1, wherein said first latch assembly further comprises a retaining plate mounted to said tailgate to retain said first latch pin in cooperation with said tailgate.

5. The cargo bed assembly of claim 1, wherein said tailgate further comprises a molded channel, said first latch pin is slidably mounted within said molded channel.

6. The cargo bed assembly of claim 1, wherein said tailgate further comprises a recessed area molded within said outer side of said tailgate, said first latch pin is operable to be positioned in said recessed area when said first latch pin is in engagement with said first side wall.

7. The cargo bed assembly of claim 1, further comprising a second latch assembly mounted to said tailgate, said second latch assembly comprising a second latch pin operable to slide into and out of engagement with said second side wall.

8. The cargo bed assembly of claim 1, wherein said first side wall further comprises a first receptacle operable to receive said first latch pin.

9. The cargo bed assembly of claim 1, wherein said cargo bed assembly further comprises a crosslinked polyethylene.

10. The cargo bed assembly of claim 1, further comprising a rigid reinforcing member extending across said tailgate.

11. The cargo bed assembly of claim 10, wherein said reinforcing member comprises aluminum.

12. A cargo bed assembly for a utility vehicle comprising:
a cargo bed base having a rear surface;
a first sidewall extending from said base;
a second side wall extending from said base, said second side wall located opposite said first side wall; and
a center flange extending from said rear surface, said center flange comprising:
a center portion mounted directly to said rear surface;
a first extension extending from a first end of said center portion, said first extension is spaced apart from said rear surface of said cargo bed; and
a second extension extending from a second end of said center portion that is opposite said first end, said second extension is spaced apart from said cargo bed; and
a tailgate comprising a center receptacle operable to cooperate with said center flange.

13. The cargo bed assembly of claim 12, wherein said center flange extends across less than an entire length of said rear surface.

14. The cargo bed assembly of claim 12, wherein said first extension and said second extension each have a smaller diameter than a diameter of said center portion.

15. The cargo bed assembly of claim 12, wherein said center flange and said base are molded together.

16. The cargo bed assembly of claim 12, wherein said center receptacle comprises:
a middle portion sized to accommodate said center portion of said center flange;
a first side portion sized to accommodate said first extension, said first side portion including a first inner wall operable to prevent passage of said first extension through said center receptacle; and
a second side portion sized to accommodate said second extension, said second side portion including a second inner wall operable to prevent passage of said second extension through said center receptacle.

17. The cargo bed assembly of claim 12, wherein said first side wall comprises a first side flange protruding from said first side wall at said rear surface of said base and said second side wall comprises a second side flange protruding from said second side wall at said rear surface of said base.

18. The cargo bed assembly of claim 12, wherein said tailgate comprises:
a first recess at a first end of said tailgate that is operable to receive a first side flange protruding from said first side wall; and
a second recess at a second end of said tailgate that is operable to receive a second side flange protruding from said second side wall.

19. The cargo bed assembly of claim 18, wherein said first recess includes a first opening operable to permit passage of said first side flange out from within said first recess and said second recess includes a second opening operable to permit passage of said second side flange out from within said second recess.

20. The cargo bed assembly of claim 12, wherein said base further comprises a lip that protrudes from said rear surface and extends between said first side wall and said center flange.

21. The cargo bed assembly of claim 12, wherein said cargo bed assembly comprises a crosslinked polyethylene.

22. A utility vehicle comprising:
a front end;
a rear end;
a seat assembly having a seat back support post;
a cargo bed mounted proximate to said rear end of said utility vehicle, said cargo bed comprising:
a base;
a forward wall extending from said base, said forward wall having a front side opposing said seat back support post and a rear side facing said rear end of said utility vehicle; and
a recess disposed in said front side of said forward wall opposite said seat back support post.

23. The utility vehicle of claim 22, wherein said recess is disposed within said forward wall to a greater depth proximate to said base than distal to said base.

24. The cargo bed assembly of claim 22, wherein said cargo bed comprises a polymeric material.

25. The cargo bed assembly of claim 22, wherein said cargo bed comprises a crosslinked polyethylene.

26. The cargo bed assembly of claim 22, wherein said rear side includes an indentation operable to accommodate a label.

27. A cargo bed assembly for a utility vehicle comprising:
a cargo bed base;
a first side wall extending from said base;
a tapered first side pocket within said first side wall, said first side pocket is tapered such that it is more narrow proximal to said base than distal to said base.

28. The cargo bed assembly of claim 27, wherein said tapered first side pocket extends an entire height of said first side wall.

29. The cargo bed assembly of claim 27, wherein said tapered first side pocket extends less than an entire height of said first side wall.

30. The cargo bed assembly of claim 27, wherein said tapered first side pocket is a divider rail pocket.

31. The cargo bed assembly of claim 27, wherein said tapered first side pocket is a stake-side pocket.

32. The cargo bed assembly of claim 27, further comprising a tapered second side pocket within a second wall that opposes said first side wall and a removable divider rail that extends between said first side pocket and said second side pocket.

33. The cargo bed assembly of claim 27, further comprising a tapered second side pocket within said first wall and a removable stake side disposed within said first side pocket and said second side pocket.

34. A cargo bed assembly for a utility vehicle comprising:
a utility vehicle frame;
a stop device mounted to said frame;
a cargo bed base pivotally mounted to said frame;
an undersurface of said base; and
a recess formed within said undersurface of said base, said recess positioned such that it receives said stop device when said cargo bed is in a horizontal position relative to said frame.

35. The cargo bed assembly of claim 34, wherein said stop device comprises a bumper.

36. The cargo bed assembly of claim 34, wherein a height of said stop device is adjustable.

37. The cargo bed assembly of claim 34, wherein said undersurface further comprises a plurality of mounting locations.

38. The cargo bed assembly of claim 37, further comprising an actuating device mounted to one of said plurality of mounting locations and to said utility vehicle frame.
